(19) United States
(12) Patent Application Publication
(10) Pub. No.: US 2020/0340175 A1
(43) Pub. Date: Oct. 29, 2020

(54) FOAMED RESIN LAYER AND SYNTHETIC LEATHER

(71) Applicants: HONDA MOTOR CO., LTD., Tokyo (JP); TRIPLE A CO., LTD., Osaka (JP)

(72) Inventors: Tomoyuki UEMURA, Wako-shi (JP); Susumu TAKAHASHI, Osaka-shi (JP); Shohei KOYAMA, Osaka-shi (JP)

(73) Assignees: HONDA MOTOR CO., LTD., Tokyo (JP); TRIPLE A CO., LTD., Osaka (JP)

(21) Appl. No.: 16/856,666

(22) Filed: Apr. 23, 2020

(30) Foreign Application Priority Data
Apr. 24, 2019 (JP) 2019-083039

(51) Int. Cl. D06N 3/00; B32B 5/20; B32B 5/24; B32B 5/02; B32B 7/12; B32B 27/06; B32B 27/08; D06N 3/06; D06N 3/12; D06N 3/14; D06N 3/18; B32B 27/40; B32B 37/02; B32B 37/24

(52) U.S. Cl. CPC D06N 3/005; B32B 2305/022; B32B 5/245; B32B 5/02; B32B 7/12; B32B 27/065; B32B 27/08; D06N 3/0056; D06N 3/06; D06N 3/121; D06N 3/142; D06N 3/145; D06N 3/183; B32B 27/40; B32B 37/02; B32B 37/24; B32B 2605/003; D06N 2203/048; D06N 2203/068; D06N 2203/063; D06N 2205/04; B32B 2037/243; B32B 2255/02; B32B 2255/102; B32B 2255/26; B32B 2266/08; B32B 2266/0235; B32B 2266/0292; B32B 2266/0278; B32B 2274/00; B32B 5/20

(57) ABSTRACT

A synthetic leather is lightweight and highly durable to abrasion, and a foamed resin layer can give the synthetic leather. The foamed resin layer includes a poly(vinyl chloride) resin and a thermoplastic polyurethane elastomer. The thermoplastic polyurethane elastomer preferably has a Shore A hardness of 50 to 80. The foamed resin layer preferably has an apparent density of 0.3 to 0.7 g/cm³. The foamed resin layer preferably has an average cell size of 50 to 250 μm.

### TECHNICAL FIELD

The present invention generally relates to foamed resin layers and synthetic leathers. More specifically, the present invention relates to a synthetic leather that is suitable for vehicle interior use, and a foamed resin layer that is suitable to be applied to the synthetic leather.

### BACKGROUND ART

Synthetic leathers have been widely used as a substitute for natural leathers, or as a leather material which has equivalent or better properties than those of natural leathers. In particular, some of the synthetic leathers are used as on-vehicle sheet materials typically for automobiles. To have touch, feel, and texture like natural leathers, the synthetic leathers may generally include a fibrous substrate (such as a nonwoven fabric, a woven fabric, or a knit fabric) and, disposed on the substrate, a resin layer mainly including a polyurethane resin or a poly(vinyl chloride) resin.

Such synthetic leathers for use as or in on-vehicle sheets require weight reduction. However, the conventional synthetic leathers using a poly(vinyl chloride) resin layer have a large weight because of a large thickness of the resin layer, and fail to meet the weight reduction requirement.

Known synthetic leathers mainly including a poly(vinyl chloride) resin include a foamed resin layer, and a skin layer disposed on the foamed resin layer. The foamed resin layer mainly includes a poly(vinyl chloride) resin. The skin layer mainly includes a poly(vinyl chloride) resin or a polyurethane resin (see Japanese Unexamined Patent Application Publication (JP-A) No. 2017-210703 and JP-A No. 2016-87867). In contrast, other known synthetic leathers mainly include a polyurethane resin (see JP-A No. 2011-214191, JP-A No. 2011-214192, and JP-A No. 2006-77349)

### SUMMARY OF INVENTION

### Technical Problem

Synthetic leathers for use as or in on-vehicle sheets, particularly as or in automobile sheets also require severe abrasion durability. However, the synthetic leathers disclosed in JP-A No. 2017-210703 and JP-A No. 2016-87867 have insufficient abrasion durability and fail to meet the required level of abrasion durability, although the synthetic leathers succeed weight reduction by using a poly(vinyl chloride) resin as a foamed layer (cellular layer). In this connection, such synthetic leathers may have better abrasion durability by allowing a non-foamed layer lying immediately below the foamed poly(vinyl chloride) resin layer to have a large thickness. Unfortunately, this synthetic leather has a large weight and tends to fail to meet the weight reduction requirement. The synthetic leather also has significantly lower feel and texture because of such a large thickness of the non-foamed layer.

The synthetic leather disclosed in JP-A No. 2011-214191, JP-A No. 2011-214192, and JP-A No. 2006-77349, which mainly includes a polyurethane resin, has a large thickness of the non-foamed layer and fails to meet the required level of weight reduction, although the synthetic leather has satisfactory abrasion durability.

The present invention has been made in consideration of these circumstances and has an object to provide a foamed resin layer that can provide a synthetic leather being lightweight and highly durable abrasion. The present invention has another object to provide a synthetic leather that is lightweight and highly durable to abrasion.

### Solution to Problem

After intensive investigations to achieve the objects, the inventors of the present invention have found that a foamed resin layer including a poly(vinyl chloride) resin and a thermoplastic polyurethane elastomer can give a synthetic leather that is lightweight and highly durable to abrasion. The inventors have also found that a synthetic leather including a specific laminate is lightweight and highly durable to abrasion. This laminate includes, in the sequence set forth, a fibrous substrate layer, a foamed resin layer, and a surface-protective layer. The fibrous substrate layer and the surface-protective layer define both end faces of the laminate. The laminate has a mass per unit area, a thickness, resistance to rubbing, and a BLC softness within specific ranges. The present invention has been made on the basis of these findings.

Specifically, the present invention provides, in an embodiment, a foamed resin layer including a poly(vinyl chloride) resin and a thermoplastic polyurethane elastomer. The foamed resin layer according to the embodiment of the present invention as above enables weight reduction while allowing the poly(vinyl chloride) resin to maintain its properties. The foamed resin layer can give a synthetic leather that is lightweight and highly durable to abrasion.

The thermoplastic polyurethane elastomer preferably has a Shore A hardness of 50 to 80. The thermoplastic polyurethane elastomer, when having a Shore A hardness within the range, has better compatibility with the poly(vinyl chloride) resin. Thus, the thermoplastic polyurethane elastomer, when having a Shore A hardness of 50 or more, allows a resin composition to exhibit excellent processability (workability) and cleavability and to be more easily pelletized, where the resin composition is a precursor of the foamed resin layer. The thermoplastic polyurethane elastomer, when having a Shore A hardness of 80 or less, allows a synthetic leather including the foamed resin layer to have higher softness and better flexing durability (in particular, better low-temperature flexing durability). In addition, the configuration contributes to better sheet processability in formation of an unfoamed resin sheet by calendering, where the unfoamed resin sheet is a precursor of the foamed resin layer.

The foamed resin layer preferably has an apparent density of 0.3 to 0.7 g/cm³. The foamed resin layer, when having an apparent density of 0.3 g/cm³ or more, allows the synthetic leather including the foamed resin layer to have better abrasion durability. The foamed resin layer, when having an apparent density of 0.7 g/cm³ or less, can have a still lighter weight, can surely have a sufficient thickness, and has more excellent softness. The foamed resin layer can maintain its strength due to the presence of the poly(vinyl chloride) resin, even when having a relatively low apparent density of 0.7 g/cm³ or less. The foamed resin layer, when having an apparent density within the range, allows the synthetic leather including the foamed resin layer to provide better feel and texture.

The foamed resin layer preferably has an average cell size of 50 to 250 μm. The foamed resin layer, when having an average cell size of 50 μm or more, has better softness. The foamed resin layer, when having an average cell size of 250 μm or less, has better abrasion durability.

The foamed resin layer preferably has a closed-cell structure. The foamed resin layer according to the embodiment of the present invention, when having the configuration, has higher abrasion durability and better flexing durability (in particular, better low-temperature flexing durability).

The foamed resin layer contains the thermoplastic polyurethane elastomer in a proportion of preferably 1 to 50 parts by mass per 100 parts by mass of the poly(vinyl chloride) resin. The foamed resin layer, when containing the thermoplastic polyurethane elastomer in a proportion of 1 part by mass or more, allows the thermoplastic polyurethane elastomer to be present in a more sufficient amount, and has higher abrasion durability and better flexing durability (in particular, better low-temperature flexing durability). The foamed resin layer, when containing the thermoplastic polyurethane elastomer in a proportion of 50 parts by mass or less, allows the poly(vinyl chloride) resin to be present in a sufficient amount and to exhibit its performance more satisfactorily.

The foamed resin layer preferably further includes a plasticizer. The foamed resin layer, when including such a plasticizer, has higher softness and better flexing durability (in particular, better low-temperature flexing durability).

The plasticizer may be present in a proportion of preferably 40 to 90 parts by mass per 100 parts by mass of the poly(vinyl chloride) resin. The foamed resin layer, when containing the plasticizer in a proportion of 40 parts by mass or more, has higher softness and better flexing durability (in particular, better low-temperature flexing durability). The foamed resin layer, when containing the plasticizer in a proportion of 90 parts by mass or less, eliminates or minimizes the bleedout of the plasticizer to the foamed resin layer surface, can maintain adhesion with an adjacent layer at high level, and provides better abrasion durability. This foamed resin layer allows the poly(vinyl chloride) resin to exhibit its inherent performance more satisfactorily. The foamed resin layer includes a thermoplastic polyurethane elastomer and has high softness and excellent flexing durability (in particular, excellent low-temperature flexing durability). This configuration allows the foamed resin layer to include such a plasticizer in a smaller proportion of 90 parts by mass or less.

The foamed resin layer is preferably for use in a synthetic leather for an automobile interior. The present invention also provides, in another embodiment, a first synthetic leather which includes the foamed resin layer. The synthetic leather including the foamed resin layer is lightweight and highly durable to abrasion.

The first synthetic leather preferably includes, in the sequence set forth, a fibrous substrate layer, the foamed resin layer, and a skin layer including a polyurethane resin, in which the fibrous substrate layer and the foamed resin layer bond with each other through a bonding layer derived mainly from a poly(vinyl chloride) resin. The first synthetic leather having the configuration as above has good adhesion between the foamed resin layer, which contains a thermoplastic polyurethane elastomer, and the skin layer, which contains a polyurethane resin. In the first synthetic leather, the foamed resin layer, which contains a thermoplastic polyurethane elastomer, bonds to the fibrous substrate layer through the bonding layer, which is mainly derived from a poly(vinyl chloride) resin. Thus, the synthetic leather has particularly excellent adhesion between adjacent layers, resists interlayer displacement, and is extremely highly durable to abrasion.

The present invention also provides, in still another embodiment, a second synthetic leather. The second synthetic leather includes a laminate that includes, in the sequence set forth, a fibrous substrate layer, a foamed resin layer, and a surface-protective layer. The surface-protective layer defines an outermost surface of the laminate. The fibrous substrate layer and the surface-protective layer define both end faces of the laminate. The laminate has a mass per unit area of 300 to 500 g/m² and a thickness of 1.0 to 1.3 mm. Assume that the second synthetic leather receives, on the surface-protective layer side, a rubbing test under a load of 1 kg with 30000 reciprocating rubbings in a test for color fastness to rubbing prescribed in JIS L0849. After the rubbing test, a layer lying immediately below the surface-protective layer in the synthetic leather remains unexposed. The second synthetic leather has a BLC softness of 4.0 to 6.0. The second synthetic leather having the configuration as above is lightweight and highly durable to abrasion. The second synthetic leather also has excellent flexing durability (in particular, excellent low-temperature flexing durability) and a good feel and texture. In the second synthetic leather, the foamed resin layer is preferably the foamed resin layer according to the embodiment of the present invention.

### Advantageous Effects of Invention

The foamed resin layer according to the embodiment of the present invention can provide a synthetic leather that is lightweight and highly durable to abrasion. The foamed resin layer according to the embodiment of the present invention can also provide a synthetic leather that has a good feel and texture, and excellent flexing durability (in particular, excellent low-temperature flexing durability). The synthetic leather according to the embodiment of the present invention is lightweight and highly durable to abrasion. In addition, the synthetic leather according to the embodiment of the present invention has a good feel and texture, and excellent flexing durability (in particular, excellent low-temperature flexing durability).

### BRIEF DESCRIPTION OF DRAWINGS

FIG. 1 is a schematic view (vertical cross-sectional view) of a synthetic leather according to an embodiment of the present invention.

### DESCRIPTION OF EMBODIMENTS

### Foamed Resin Layer

A foamed resin layer according to the embodiment of the present invention includes a poly(vinyl chloride) resin and a thermoplastic polyurethane elastomer. The foamed resin layer may include each of different poly(vinyl chloride) resins and each of different thermoplastic polyurethane elastomers, alone or in combination.

The poly(vinyl chloride) resin is a polymer derived from a monomer or monomers essentially including vinyl chloride or vinylidene chloride. Specifically, the poly(vinyl chloride) resin is a polymer including a constitutional unit derived from vinyl chloride or vinylidene chloride in the molecule (per molecule).

Non-limiting examples of the poly(vinyl chloride) resin include poly(vinyl chloride)s, which are vinyl chloride homopolymers; poly(vinylidene chloride)s, which are vinylidene chloride homopolymers; copolymers of vinyl chloride or vinylidene chloride with another monomer; chlorinated poly(vinyl chloride)s; and chlorinated polyolefins. Non-limiting examples of the chlorinated polyolefins include chlorinated polyethylenes and chlorinated polypropylenes.

Non-limiting examples of the copolymers include vinyl chloride-vinyl acetate copolymers, vinyl chloride-ethylene copolymers, vinyl chloride-propylene copolymers, vinyl chloride-styrene copolymers, vinyl chloride-isobutylene copolymers, vinyl chloride-vinylidene chloride copolymers, vinyl chloride-urethane copolymers, vinyl chloride-butadiene copolymers, vinyl chloride-isoprene copolymers, and vinyl chloride-chlorinated propylene copolymers; vinyl chloride-vinyl ester copolymers such as vinyl chloride-maleic acid ester copolymers and vinyl chloride-(meth)acrylic acid ester copolymers; as well as vinyl chloride-acrylonitrile copolymers, vinyl chloride-vinyl ether copolymers, vinyl chloride-styrene-maleic anhydride ternary copolymers, vinyl chloride-styrene-acrylonitrile ternary copolymers, vinyl chloride-vinylidene chloride-vinyl acetate ternary copolymers, and ethylene-vinyl acetate-vinyl chloride copolymers. The category of the copolymers includes block copolymers, random copolymers, and graft copolymers.

Among them, the poly(vinyl chloride) resin is preferably a poly(vinyl chloride) (vinyl chloride homopolymer).

The poly(vinyl chloride) resin can be obtained by known or common polymerization. The poly(vinyl chloride) resin may be obtained by any polymerization technique, such as emulsion polymerization, suspension polymerization, bulk polymerization, or solution polymerization. In particular, the poly(vinyl chloride) resin is preferably one resulting from emulsion polymerization or suspension polymerization.

The poly(vinyl chloride) resin has an average degree of polymerization of preferably 1100 to 3500, more preferably 1200 to 3000, and still more preferably 1300 to 2800, although the poly(vinyl chloride) resin may have any other average degree of polymerization. The average degree of polymerization herein is determined in conformity to JIS K6721. The poly(vinyl chloride) resin, when having an average degree of polymerization of 1100 or more, contributes to higher abrasion durability and better flexing durability (in particular, better low-temperature flexing durability). The poly(vinyl chloride) resin, when having an average degree of polymerization of 4000 or less, contributes to better processability of an unfoamed resin sheet to be formed by calendering, where the unfoamed resin sheet is a precursor of the foamed resin layer according to the embodiment of the present invention.

The poly(vinyl chloride) resin has an average particle diameter of preferably 0.1 to 5 μm, and more preferably 0.2 to 4 μm, although the poly(vinyl chloride) resin may have any other average particle diameter. The poly(vinyl chloride) resin, when having an average particle diameter of 0.1 μm or more, allows the unfoamed resin sheet to be produced through calendering with good productivity. The poly(vinyl chloride) resin, when having an average particle diameter of 5 μm or less, allows the thermoplastic polyurethane elastomer particles to disperse satisfactorily in the vinyl chloride composition (vinyl chloride matrix). The average particle diameter is a value measured by a laser diffraction scattering technique.

The thermoplastic polyurethane elastomer (TPU) includes a hard phase (hard segment) and a soft phase (soft segment). The thermoplastic polyurethane elastomer generally results from the reaction among a polyisocyanate, a long-chain polyol, a chain extender, and, as needed, another isocyanate-reactive compound.

The polyisocyanate is a compound containing two or more isocyanate groups per molecule. Non-limiting examples of the polyisocyanate include aliphatic polyisocyanates, alicyclic polyisocyanates, aromatic polyisocyanates, and araliphatic polyisocyanates. Non-limiting examples of the polyisocyanate also include dimers, trimers, reaction products, and polymerized products derived from the aliphatic polyisocyanates, alicyclic polyisocyanates, aromatic polyisocyanates, and/or araliphatic polyisocyanates, such as dimers and trimers of diphenylmethane diisocyanate, reaction products between trimethylolpropane and tolylene diisocyanate, reaction products between trimethylolpropane and hexamethylene diisocyanate, polymethylene polyphenyl isocyanates, polyether polyisocyanates, and polyester polyisocyanates. The thermoplastic polyurethane elastomer may be derived from each of different polyisocyanates alone or in combination.

Non-limiting examples of the long-chain polyols include polyether polyols, polyester polyols, polycarbonate polyols, polyolefin polyols, and polyacrylic polyols. Such a long-chain polyol may have a number-average molecular weight of generally 500 or more, preferably 500 to 10000, more preferably 600 to 6000, and still more preferably 800 to 4000. The thermoplastic polyurethane elastomer may be derived from each of different long-chain polyols alone or in combination.

The chain extender for use herein can be selected from chain extenders generally used for the production of thermoplastic polyurethane elastomers. Non-limiting examples of the chain extender include low-molecular-weight polyols and polyamines. The chain extender has a molecular weight of generally less than 500, and preferably 300 or less. The thermoplastic polyurethane elastomer may be derived from each of different chain extenders alone or in combination.

The thermoplastic polyurethane elastomer has a Shore A hardness of preferably 50 to 80, and more preferably 55 to 75. The thermoplastic polyurethane elastomer, when having a Shore A hardness within the range, has still better compatibility with the poly(vinyl chloride) resin. Thus, the thermoplastic polyurethane elastomer, when having a Shore A hardness of 50 or more, allows a resin composition to have excellent processability and cleavability and to be pelletized more easily, where the resin composition is a precursor of the foamed resin layer according to the embodiment of the present invention. The thermoplastic polyurethane elastomer, when having a Shore A hardness of 80 or less, allows a synthetic leather including the foamed resin layer according to the embodiment of the present invention to have higher softness and better flexing durability (in particular, better low-temperature flexing durability). In addition, this thermoplastic polyurethane elastomer has good compatibility with the poly(vinyl chloride) resin and allows an unfoamed resin sheet to be produced by calendering with excellent sheet processability, where the unfoamed resin sheet is a precursor of the foamed resin layer according to the embodiment of the present invention.

The thermoplastic polyurethane elastomer has a melting point of preferably 140° C. to 200° C., and more preferably 150° C. to 180° C. The thermoplastic polyurethane elastomer, when having a melting point of 140° C. or higher, allows the foamed resin layer to be formed satisfactorily and to maintain its heat resistance when the foamed resin layer is used as or in an automobile interior material. The thermoplastic polyurethane elastomer, when having a melting point of 200° C. or lower, has satisfactory compatibility with the poly(vinyl chloride) resin and provides good processability in calendering (calenderability).

The thermoplastic polyurethane elastomer is present in a proportion of preferably 1 to 50 parts by mass, more preferably 5 to 45 parts by mass, and still more preferably 8 to 35 parts by mass, per 100 parts by mass of the poly(vinyl chloride) resin. The thermoplastic polyurethane elastomer, when present in a proportion of 1 part by mass or more, is present in a more sufficient amount and contributes to higher abrasion durability and better flexing durability (in particular, better low-temperature flexing durability). The thermoplastic polyurethane elastomer, when present in a proportion of 50 parts by mass or less, allows the poly(vinyl chloride) resin to be present in a sufficient amount and to exhibit its performance more satisfactorily. The thermoplastic polyurethane elastomer having this configuration provides good processability in calendering to form the unfoamed resin sheet.

The foamed resin layer according to the embodiment of the present invention preferably further includes a plasticizer. The foamed resin layer according to the embodiment of the present invention, when containing such a plasticizer, contributes to still better softness (flexibility) and better flexing durability (in particular, better low-temperature flexing durability), of the foamed resin layer and the synthetic leather according to the embodiments of the present invention.

The plasticizer for use herein can be selected from common ones for use in poly(vinyl chloride) resins. Non-limiting examples of such plasticizers include aromatic carboxylic esters such as di-2-ethylhexyl phthalate, di-n-octyl phthalate, diisooctyl phthalate, dinonyl phthalate, diisononyl phthalate, diisodecyl phthalate, C₉-C₁₁-mixed alkyl phthalates, butyl benzyl phthalate, and diisooctyl isophthalate; aliphatic carboxylic esters such as diisooctyl adipate, diisodecyl adipate, and di-2-ethylhexyl sebacate; trimellitic acid esters such as tri-n-butyl trimellitate (TBTM) and tris(2-ethylhexyl) trimellitate (TOTM); dibenzoic acid esters such as diethylene glycol dibenzoate, dipropylene glycol dibenzoate, polyoxypropylene glycol dibenzoates, and polyoxyethylene glycol dibenzoates; phosphoric esters such as tricresyl phosphate and trixylyl phosphate; halogen-containing compounds such as chlorinated paraffin and chlorinated fatty acid esters; epoxy-containing fatty acids such as epoxidized soybean oil, epoxidized linseed oil, epoxidized safflower oil, and epoxidized castor oil; and polyesters. The foamed resin layer may include each of different plasticizers alone or in combination.

The plasticizer may be present in a proportion of preferably 40 to 90 parts by mass, and more preferably 60 to 90 parts by mass, per 100 parts by mass of the poly(vinyl chloride) resin. The foamed resin layer, when including the plasticizer in a proportion of 40 parts by mass or more, may have higher softness and better flexing durability (in particular, better low-temperature flexing durability). The foamed resin layer, when including the plasticizer in a proportion of 90 parts by mass or less, resists bleedout of the plasticizer to the foamed resin layer surface, can maintain its adhesion to an adjacent layer at high level, and has still better abrasion durability. This foamed resin layer allows the poly(vinyl chloride) resin to exhibit its inherent performance more satisfactorily. The foamed resin layer according to the embodiment of the present invention includes the thermoplastic polyurethane elastomer and has high softness and excellent flexing durability (in particular, excellent low-temperature flexing durability). This configuration allows the plasticizer to be present in a relatively small proportion of 90 parts by mass or less.

The foamed resin layer according to the embodiment of the present invention preferably further includes a filler. The foamed resin layer according to the embodiment of the present invention, when including such a filler, can have higher rigidity and better durability.

Non-limiting examples of the filler include inorganic fillers such as calcium carbonate, calcium phosphate, calcium phosphite, calcium sulfate, calcium sulfite, calcium borate, calcium silicate, calcium oxide, calcium hydroxide, magnesium carbonate, magnesium oxide, magnesium hydroxide, barium sulfate, aluminum hydroxide, titanium oxide, antimony oxide, silica, zinc borate, zinc stannate, zinc hydroxystannate, alum, talc, kaolin, clay, asbestos, synthetic zeolite, and synthetic hydrotalcite. The foamed resin layer may include each of different fillers alone or in combination.

The foamed resin layer may contain the filler in a proportion of preferably 1 to 100 parts by mass, and more preferably 5 to 30 parts by mass, per 100 parts by mass of the poly(vinyl chloride) resin. The foamed resin layer, when containing the filler in a proportion of 1 part by mass or more, can more easily form a closed-cell structure and can have higher rigidity and better durability. The foamed resin layer, when containing the filler in a proportion of 100 parts by mass or less, can contain the filler without affecting the flexing durability and abrasion durability.

The foamed resin layer according to the embodiment of the present invention may further contain any of other components than the above-mentioned components, within ranges not adversely affecting the advantageous effects of the present invention. Examples of the other components include components to be contained in known or common foams. Non-limiting examples of such other components include resins other than poly(vinyl chloride) resins and thermoplastic polyurethane elastomers, processing aids, reinforcers, flame retardants, colorants (such as dyes and pigments), antifoaming agents, leveling agents, crosslinkers, silane coupling agents, thixotropes, tackifiers, waxes, thermal stabilizers and other stabilizers, light fastness improvers, ultraviolet absorbers, weatherability improvers, fluorescent brighteners, conductivity imparting agents, antistatic agents, moisture-permeability improvers, water-repellents, oil-repellents, blowing agents, combined water-containing compounds, water absorbents, moisture absorbents, deodorants, foam stabilizers, anti-fogging agents, antifungal agents, antiseptic agents, antialgal agents, pigment dispersants, inert gases, slipping agents, lubricants, antiblocking agents, hydrolysis inhibitors, neutralizers, natural oils, synthetic oils, and thickeners. The foamed resin layer may contain each of different other components alone or in combination.

The foamed resin layer according to the embodiment of the present invention has an apparent density of preferably 0.3 to 0.7 g/cm³, and more preferably 0.4 to 0.5 g/cm³. The foamed resin layer according to the embodiment of the present invention, when having an apparent density of 0.3 g/cm³ or more, allows the synthetic leather using the foamed resin layer to have better abrasion durability. The foamed resin layer, when having an apparent density of 0.7 g/cm³ or less, has a lighter weight, can surely have a sufficient thickness, and has better softness. The foamed resin layer according to the embodiment of the present invention, even when having a relatively low apparent density of 0.7 g/cm³ or less, can maintain its strength due to the presence of the poly(vinyl chloride) resin. The foamed resin layer according to the embodiment of the present invention, when having an apparent density controlled within the range, allows the synthetic leather including the foamed resin layer to have a better feel and texture. The apparent density is determined by cutting a sample foamed resin layer to 30-cm square pieces, measuring the thicknesses of five pieces of the foamed resin layer, averaging the five measurements, calculating the volume of one piece of the foamed resin layer, and calculating the apparent density from the mass and the volume of the piece of the foamed resin layer.

The foamed resin layer according to the embodiment of the present invention has an average cell size (average cell diameter) of preferably 50 to 250 μm, more preferably 55 to 160 μm, and still more preferably 60 to 100 μm. The foamed resin layer, when having an average cell size of 50 μm or more, may have better softness. The foamed resin layer, when having an average cell size of 250 μm or less, may have better abrasion durability.

The foamed resin layer according to the embodiment of the present invention has a maximum cell size of preferably 80 to 400 μm, more preferably 90 to 250 μm, and still more preferably 100 to 200 μm. The foamed resin layer, when having a maximum cell size of 80 μm or more, may have better softness. The foamed resin layer, when having a maximum cell size of 400 μm or less, may have better abrasion durability.

The foamed resin layer according to the embodiment of the present invention has an expansion ratio (degree of foaming) of preferably 1.3 to 3.0 times, and more preferably 1.7 to 2.2 times. The foamed resin layer, when having an expansion ratio of 1.3 times or more, has a lighter weight, can surely have a sufficient thickness, and has better softness. The foamed resin layer according to the embodiment of the present invention, even when having a relatively high expansion ratio of 1.3 times or more, can maintain its strength due to the presence of the poly(vinyl chloride) resin. The foamed resin layer according to the embodiment of the present invention, when having an expansion ratio of 3.0 times or less, allows the synthetic leather using the foamed resin layer to have better abrasion durability. In addition, the foamed resin layer according to the embodiment of the present invention, when controlled to have an expansion ratio within the range, allows the synthetic leather using the foamed resin layer to have a better feel and texture.

The expansion ratio may be determined in the following manner. An electron photomicrograph (50-fold magnification) of a cross-section of a sample foamed resin layer is taken in the thickness direction, read into a personal computer using a scanner, foamed portions are white-filled, the colors of the foamed portions and unfoamed portions are binarized to black and white, and white dots are counted by integration. The expansion ratio is then determined according to the following equation:

Expansion ratio=((Area of foamed portions)+(Area of unfoamed portions))/(Area of unfoamed portions)

The foamed resin layer according to the embodiment of the present invention may have, as a cell structure, any of a closed-cell structure, a semi-closed-semi-open-cell structure, and an open-cell structure, but preferably has a closed-cell structure. The foamed resin layer, when having a closed-cell structure, may have higher abrasion durability and better flexing durability (in particular, better low-temperature flexing durability).

The foamed resin layer according to the embodiment of the present invention contains the poly(vinyl chloride) resin and the thermoplastic polyurethane elastomer and can thereby give a synthetic leather that is lightweight and highly durable to abrasion. In particular, the foamed resin layer can be optimized in hardness balance by regulating the average degree of polymerization of the poly(vinyl chloride) resin, the content of the thermoplastic polyurethane elastomer, the content of the plasticizer, and the expansion ratio of the foamed resin layer within preferred ranges. This foamed resin layer allows the synthetic leather including the foamed resin layer to have abrasion durability and flexing durability (in particular, low-temperature flexing durability) at very high levels, while having a lighter weight.

The foamed resin layer according to the embodiment of the present invention has an Asker C hardness of preferably 25 to 55, more preferably 30 to 45, and still more preferably 35 to 40, although the foamed resin layer may have any other Asker C hardness. The Asker C hardness herein is measured according to JIS K7312. The foamed resin layer, when having an Asker C hardness of 25 or more, allows the synthetic leather to have still better abrasion durability. The foamed resin layer, when having an Asker C hardness of 55 or less, allows the synthetic leather to have a better feel and texture and to have still better flexing durability (in particular, better low-temperature flexing durability).

The foamed resin layer according to the embodiment of the present invention has a thickness of preferably 200 to 650 μm, more preferably 250 to 600 μm, and still more preferably 300 to 500 μm, although the foamed resin layer may have any other thickness. The foamed resin layer, when having a thickness of 200 μm or more, may have better abrasion durability. The foamed resin layer, when having a thickness of 650 μm or less, can have a lighter weight.

The foamed resin layer according to the embodiment of the present invention can be prepared typically in the following manner. Initially, the poly(vinyl chloride) resin, the thermoplastic polyurethane elastomer, and one or more other resins as needed melt by heating and mix with each other. In addition, the mixture further is mixed and kneaded with a plasticizer, a filler, the other component(s), and one or more additives as needed, is cooled, and yields a resin composition (such as pellets). Non-limiting examples of the additives include blowing agents, expansion accelerators, and cell regulators. Preferred contents of the components such as the poly(vinyl chloride) resin and the thermoplastic polyurethane elastomer in the resin composition are as with the corresponding contents in the foamed resin layer according to the embodiment of the present invention.

Non-limiting examples of the blowing agent include supercritical fluids; inorganic blowing agents such as ammonium carbonate, ammonium hydrogencarbonate, sodium hydrogencarbonate, ammonium nitrite, sodium borohydride, and azides; organic blowing agents such as azo blowing agents, nitroso blowing agents, hydrazide blowing agents, carbazide blowing agents, and triazine blowing agents; thermally expandable compounds such as isobutane and pentane; and thermally expandable fine particles (thermally expandable microcapsules) each including any of the thermally expandable compounds encapsulated in a microcapsule derived from a thermoplastic resin such as a poly(vinylidene chloride), a polyacrylonitrile, or a poly(meth)acrylate. The resin composition may include each of different blowing agents alone or in combination.

Non-limiting examples of the azo blowing agents include azodicarbonamide, azobisisobutyronitrile, diazoaminobenzene, diethyl azodicarboxylate, diisopropyl azodicarboxylate, and azobis(hexahydrobenzonitrile). Non-limiting examples of the nitroso blowing agents include N,N′-dimethyl-N,N′-dinitroterephthalamine and N,N′-dinitropentamethylenetetramine. Non-limiting examples of the hydrazide blowing agents include benzenesulfonyl hydrazide, p-toluenesulfonyl hydrazide, 3,3′-disulfone hydrazide phenylsulfone, toluene disulfonyl hydrazone, thiobis(benzenesulfonyl hydrazide), and p,p′-oxybis(benzenesulfonyl hydrazide). Non-limiting examples of the carbazide blowing agents include p-toluenesulfonylsemicarbazide and 4,4′-oxybis(benzenesulfonylsemicarbazide). Non-limiting examples of the triazine blowing agents include trihydrazinotriazine and 1,3-bis(o-biphenyltriazine).

The foamed resin layer according to the embodiment of the present invention is preferably one formed using a blowing agent and particularly preferably one formed using thermally expandable microcapsules. The foamed resin layer, when formed using a blowing agent, can include cells having uniform cell sizes, as compared with ones foamed by another mechanism such as mechanical stirring. The foamed resin layer, when formed using thermally expandable microcapsules, can be a foamed resin layer having smaller and more uniform cell sizes.

The resin composition may contain the blowing agent in a proportion of typically preferably 0.1 to 10 parts by mass, and more preferably 1 to 5 parts by mass, per 100 parts by mass of the poly(vinyl chloride) resin, although the proportion is not limited and can be selected appropriately according to the intended use of the foamed resin layer to be obtained.

Next, the resin composition forms a foamed resin layer. For example, the resin composition containing a blowing agent melts or dissolves, is applied onto an after-mentioned base, such as a non-foamed resin layer or release sheet, to form a coat layer. The coat layer undergoes a heat treatment using a heater such as an oven as needed with pressurization, to allow the blowing agent to expand, and, to allow a solvent, when contained in the resin composition, to volatilize. This gives a foamed resin layer. The resin composition can be applied by a known or common technique such as reverse coating, roll coating, die coating, wire bar coating, or knife coating. Alternatively, the foamed resin layer can be formed in the following manner. The resin composition is not applied onto the base, but formed into a sheet without such a base, to form an unfoamed resin sheet. The unfoamed resin sheet undergoes a heat treatment using a heater such as an oven as needed with pressurization, to allow the blowing agent to expand, and to allow a solvent, when contained in the resin composition, to volatilize. This gives the foamed resin layer. The unfoamed resin sheet can be formed by a known or common technique, but is preferably formed by calendaring. This is because the calendering technique can easily give a sheet from such a resin composition having a high viscosity and can give a broad synthetic leather.

The foamed resin layer according to the embodiment of the present invention can give a synthetic leather that is lightweight and highly durable to abrasion. The foamed resin layer is therefore preferably used in a synthetic leather, and is more preferably used in a synthetic leather for a vehicle interior (in particular, a synthetic leather for an automobile interior), and is still more preferably used in a synthetic leather for an on-vehicle sheet (in particular, a synthetic leather for an automobile sheet).

Synthetic Leather A synthetic leather including the foamed resin layer according to the embodiment of the present invention is hereinafter also referred to as a “first synthetic leather according to the embodiment of the present invention”. The first synthetic leather according to the embodiment of the present invention, which includes the foamed resin layer according to the embodiment of the present invention, is lightweight and highly durable to abrasion. In addition, the synthetic leather has excellent flexing durability (in particular, excellent low-temperature flexing durability) and a good feel and texture.

The first synthetic leather according to the embodiment of the present invention preferably includes, in the sequence set forth, a fibrous substrate layer, the foamed resin layer according to the embodiment of the present invention, and a skin layer. The fibrous substrate layer and the foamed resin layer preferably bond with each other through a bonding layer.

The present invention also provides another synthetic leather. This synthetic leather is also referred to as a “second synthetic leather according to the embodiment of the present invention”. The second synthetic leather includes a laminate. The laminate includes, in the sequence set forth, a fibrous substrate layer, a foamed resin layer, and a surface-protective layer. The fibrous substrate layer and the surface-protective layer define both end faces of the laminate. The laminate has a mass per unit area of 300 to 500 g/m² and a thickness of 1.0 to 1.3 mm. In the laminate, a layer lying immediately below the surface-protective layer remains unexposed when the laminate receives, on the surface-protective layer side, a rubbing test under a load of 1 kg with 30000 reciprocating rubbings as a test for color fastness to rubbing prescribed in JIS L0849. The laminate has a BLC softness of 4.0 to 6.0. The second synthetic leather according to the embodiment of the present invention, which has the configuration as above, is lightweight and highly durable to abrasion. The second synthetic leather also has excellent flexing durability (in particular, excellent low-temperature flexing durability) and a good feel and texture.

The foamed resin layer in the second synthetic leather according to the embodiment of the present invention is preferably the foamed resin layer according to the embodiment of the present invention. In the second synthetic leather according to the embodiment of the present invention, the fibrous substrate layer and the foamed resin layer preferably bond with each other through a bonding layer. The second synthetic leather according to the embodiment of the present invention preferably includes a skin layer between the foamed resin layer and the surface-protective layer.

Herein, the first synthetic leather according to the embodiment of the present invention and the second synthetic leather according to the embodiment of the present invention are also generically referred to as a “synthetic leather according to the embodiment of the present invention”.

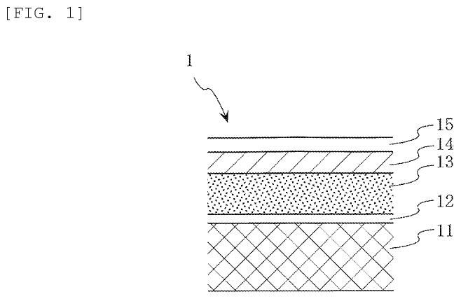

A synthetic leather according to an embodiment of the present invention is illustrated in FIG. 1. As illustrated in FIG. 1, the synthetic leather 1 according to the embodiment of the present invention includes, in the following sequence, a fibrous substrate layer 11, a foamed resin layer 13 according to the embodiment of the present invention, a skin layer 14, and a surface-protective layer 15. The surface-protective layer 15 defines an outermost surface of the synthetic leather 1. The fibrous substrate layer 11 and the foamed resin layer 13 bond with each other through a bonding layer 12.

The fibrous substrate layer in the synthetic leather according to the embodiment of the present invention may be a fibrous cloth such as a woven fabric, a knit fabric, or a nonwoven fabric, or a fibrous base such as natural leather. The fibrous cloth may be made of any fibers. Non-limiting examples of such fibers include synthetic fibers such as fibers typically of polyester resins, polyamide resins, polyacrylonitrile resins, polyolefin resins, and poly(vinyl alcohol)s; natural fibers such as cotton and hemp; regenerated fibers such as rayon, staple fibers, and acetate fibers; and semi-synthetic fibers. The fibrous cloth may be made of each of different fibers alone or in combination. In particular, from the viewpoint of better strength and workability, the fibrous substrate layer is preferably selected from knit fabrics made of synthetic fibers, and particularly preferably selected from knit fabrics made from polyester fibers. The fibrous substrate layer may have a single-layer structure or a multilayer structure.

The fibrous substrate layer has a mass per unit area (METSUKE) of preferably 100 to 300 g/m², and more preferably 150 to 200 g/m², although the fibrous substrate layer may have any other mass per unit. The fibrous substrate layer, when having a mass per unit area of 100 g/m² or more, allows the synthetic leather according to the embodiment of the present invention to have a sufficient strength as an automobile interior material. The fibrous substrate layer, when having a mass per unit area of 300 g/m² or less, allows the synthetic leather to meet desired weight reduction requirement.

The bonding layer in the synthetic leather according to the embodiment of the present invention is a layer to impart adhesiveness between the fibrous substrate layer and the foamed resin layer. Non-limiting examples of an adhesive to form the bonding layer include poly(vinyl chloride) adhesives, polyurethane adhesives, epoxy resin adhesives, polyester adhesives, rubber adhesives, acrylic resin adhesives, urea resin adhesives, phenolic resin adhesives, and melamine resin adhesives. Among them, poly(vinyl chloride) adhesives are preferred. Accordingly, the bonding layer is preferably derived mainly from a poly(vinyl chloride) resin (namely, is preferably derived from a poly(vinyl chloride) resin as an adhesive component). The bonding layer, when mainly derived from a poly(vinyl chloride) resin, contributes to better adhesion between the fibrous substrate layer and the foamed resin layer according to the embodiment of the present invention, which includes a poly(vinyl chloride) resin. This eliminates or minimizes interlayer displacement between the fibrous substrate layer and the foamed resin layer and allows the synthetic leather to be extremely highly durable to abrasion.

Non-limiting examples of the poly(vinyl chloride) resin to form the bonding layer include those exemplified and described as the poly(vinyl chloride) resin to be contained in the foamed resin layer according to the embodiment of the present invention. The poly(vinyl chloride) resin is preferably a poly(vinyl chloride). The bonding layer may be derived from each of different poly(vinyl chloride) resins alone or in combination.

The fibrous substrate layer may be partially impregnated with the bonding layer. The partial impregnation contributes to better adhesiveness between the fibrous substrate layer and the foamed resin layer according to the embodiment of the present invention.

The bonding layer has a mass per unit area of preferably 10 to 50 g/m², and more preferably 15 to 30 g/m². The bonding layer, when having a mass per unit area of 10 g/m² or more, provides better adhesion between the fibrous substrate layer and the foamed resin layer and allows the synthetic leather according to the embodiment of the present invention to have better abrasion durability. The bonding layer, when having a mass per unit area of 50 g/m² or less, allows the synthetic leather to have a still lighter weight.

The skin layer in the synthetic leather according to the embodiment of the present invention is preferably a non-foamed resin layer, to provide still better abrasion durability. The skin layer preferably includes a polyurethane resin. The skin layer, when including a polyurethane resin, has better adhesion with the foamed resin layer according to the embodiment of the present invention, which includes the thermoplastic polyurethane elastomer. This configuration more restrains interlayer displacement between the skin layer and the foamed resin layer and provides extremely good abrasion durability. The configuration also allows the synthetic leather according to the embodiment of the present invention to have a better feel and texture. The skin layer (non-foamed resin layer) may have a single-layer structure or a multilayer structure.

The polyurethane resin generally results from the reaction among a polyisocyanate, a long-chain polyol, a chain extender, and, as needed, another isocyanate-reactive compound. Examples of the polyisocyanate, long-chain polyol, and chain extender are as with corresponding ones exemplified and described as components from which the thermoplastic polyurethane elastomer in the foamed resin layer according to the embodiment of the present invention is derived. The polyurethane resin may be derived from each of different polyisocyanates, each of different long-chain polyols, and each of different chain extenders, alone or in combination.

The long-chain polyol for use herein is preferably selected from polycarbonate polyols. Specifically, the polyurethane resin usable in the skin layer is preferably a polycarbonate polyurethane resin. The use of such a polycarbonate polyurethane resin allows the synthetic leather according to the embodiment of the present invention to have better abrasion durability.

The polyurethane resin in the skin layer is preferably an aqueous polyurethane resin. Specifically, the polyurethane resin is preferably an aqueous polycarbonate polyurethane resin. This configuration allows the skin layer to provide not only more excellent abrasion durability, but also excellent resistance to oleic acid (oleic acid resistance), which is derived from sebum (skin surface lipids) components. In addition, the configuration eliminates the need for organic solvents and contributes to a reduced environmental load.

The skin layer may contain the polyurethane resin (in particular, the polycarbonate polyurethane resin) in any proportion, but in a proportion of preferably 30 mass percent or more, and more preferably 50 mass percent or more, of the totality (100 mass percent) of the skin layer. The skin layer, when containing such a polyurethane resin in a proportion of 50 mass percent or more, has better adhesion with the foamed resin layer according to the embodiment of the present invention, and this contributes to still better abrasion durability of the synthetic leather according to the embodiment of the present invention.

The skin layer may further contain one or more other components than the polyurethane resin, within ranges not adversely affecting the advantageous effects of the present invention. Examples of the other components are as with those exemplified as the other components which the foamed resin layer according to the embodiment of the present invention may contain. The skin layer may contain each of different other components alone or in combination.

The skin layer has a thickness of preferably 10 to 100 μm, and more preferably 20 to 40 μm, although the skin layer may have any other thickness. The skin layer, when having a thickness of 10 μm or more, allows the synthetic leather according to the embodiment of the present invention to have better abrasion durability. The skin layer, when having a thickness of 100 μm or less, contributes to still more weight reduction of the synthetic leather.

The surface-protective layer in the synthetic leather according to the embodiment of the present invention is a layer that defines an outermost surface of the synthetic leather; and is a layer that protects inner layers such as the skin layer and the foamed resin layer typically from rubbing. The surface-protective layer contributes to still better abrasion durability of the synthetic leather according to the embodiment of the present invention.

The surface-protective layer preferably includes a polyurethane resin. The surface-protective layer, when including a polyurethane resin, has better adhesion with such a skin layer containing a polyurethane resin. This configuration still eliminates or minimizes the interlayer displacement between the surface-protective layer and the skin layer and provides extremely good abrasion durability. The configuration also allows the synthetic leather according to the embodiment of the present invention to have a better feel and texture.

The polyurethane resin generally results from the reaction among a polyisocyanate, a long-chain polyol, a chain extender, and, as needed, another isocyanate-reactive compound. Examples of the polyisocyanate, long-chain polyol, and chain extender are as with corresponding ones exemplified and described as the components to form the thermoplastic polyurethane elastomer to be contained in the foamed resin layer according to the embodiment of the present invention. The polyurethane resin may be derived from each of different polyisocyanates, each of different long-chain polyols, and each of different chain extenders, alone or in combination.

The long-chain polyol is preferably selected from polycarbonate polyols. Specifically, the polyurethane resin compoundable into the surface-protective layer is preferably a polycarbonate polyurethane resin. The presence of the polycarbonate polyurethane resin contributes to better abrasion durability of the synthetic leather according to the embodiment of the present invention.

The polyurethane resin in the surface-protective layer is preferably an aqueous polyurethane resin. Specifically, the polyurethane resin is preferably an aqueous polycarbonate polyurethane resin. The surface-protective layer, when having the configuration as above, has better adhesion with such a skin layer containing an aqueous polyurethane resin, and this contributes to still better abrasion durability and still better oleic acid resistance. The configuration also eliminates the need for organic solvents and contributes to a reduced environmental load.

The surface-protective layer may contain a polyurethane resin (in particular, a polycarbonate polyurethane resin) in any proportion, but in a proportion of preferably 60 mass percent or more, and more preferably 90 mass percent or more, of the totality (100 mass percent) of the surface-protective layer. The surface-protective layer, when containing such a polyurethane resin (in particular, a polycarbonate polyurethane resin) in a proportion of 60 mass percent or more, contributes to extremely good abrasion durability of the synthetic leather according to the embodiment of the present invention. The proportion may be 100 mass percent.

The polyurethane resin (in particular, aqueous polycarbonate polyurethane resin) in the surface-protective layer preferably crosslinks through a carbodiimide crosslinker. Non-limiting examples of the carbodiimide crosslinker include dicyclohexylmethanecarbodiimide, dicyclohexylcarbodiimide, tetramethylxylylenecarbodiimide, and urea-modified carbodiimides. The carbodiimide crosslinker is preferably an aqueous carbodiimide crosslinker. The polyurethane resin may crosslink through each of different carbodiimide crosslinkers alone or in combination.

In particular, the surface-protective layer preferably includes an aqueous polycarbonate polyurethane resin that crosslinks through an aqueous carbodiimide crosslinker. This surface-protective layer is a crosslinked membrane (layer) that is highly resistant to oleic acid and provides not only excellent abrasion durability, but also excellent oleic acid resistance. The resulting synthetic leather according to the embodiment of the present invention can maintain good abrasion durability even in use in a place where adhesion or deposition typically of sweat, sebum, or moisturizing lotions may occur, where the deposition will occur by the contact of human body.

The proportion of a component derived from the carbodiimide crosslinker in the surface-protective layer (namely, the proportion of the carbodiimide crosslinker to be used for the formation of the surface-protective layer) is not limited, but preferably 0.5 to 10.0 parts by mass, and more preferably 2.0 to 5.0 parts by mass, per 100 parts by mass of the polyurethane resin.

The surface-protective layer preferably further includes a silicone compound. The surface-protective layer, when containing such a silicone compound, has higher surface smoothness and contributes to still better abrasion durability of the synthetic leather. The surface-protective layer may include each of different silicone compounds alone or in combination.

The silicone compound is preferably a silicone compound having 2000 or less siloxane bonds. Non-limiting examples of the silicone compound include silicone oils, modified silicone oils, and silicone resins.

Non-limiting examples of the silicone oils (linear silicone oils) include dimethylsilicone oils and methylphenylsilicone oils.

Non-limiting examples of the modified silicone oils include polyether-modified silicone oils (such as polyether-modified dimethylsilicone oils), alkyl-modified silicone oils (such as alkyl-modified dimethylsilicone oils), aralkyl-modified silicone oils (such as aralkyl-modified dimethylsilicone oils), higher fatty acid ester-modified silicone oils (such as higher fatty acid ester-modified dimethylsilicone oils), and fluoroalkyl-modified silicone oils (such as fluoroalkyl-modified dimethylsilicone oils).

Examples of the silicone resins include linear silicone resins and modified silicone resins. Non-limiting examples of the linear silicone resins include methylsilicone resins and methylphenylsilicone resins. Non-limiting examples of the modified silicone resins include alkyd-modified silicone resins, epoxy-modified silicone resins, acryl-modified silicone resins, and polyester-modified silicone resins.

The surface-protective layer may contain the silicone compound in any proportion, but in a proportion of preferably 3.0 to 20.0 parts by mass, and more preferably 6.0 to 13.0 parts by mass, per 100 parts by mass of the polyurethane resin.

The surface-protective layer may further contain one or more components other than the above-mentioned components, within ranges not adversely affecting the advantageous effects of the present invention. Non-limiting examples of such other components include those exemplified as the other components compoundable into the foamed resin layer according to the embodiment of the present invention. The surface-protective layer may contain each of different other components alone or in combination.

The surface-protective layer has a thickness of preferably 5 to 40 μm, and more preferably 10 to 20 μm, although the surface-protective layer may have any other thickness. The surface-protective layer, when having a thickness of 5 μm or more, contributes to better abrasion durability of the synthetic leather according to the embodiment of the present invention. The surface-protective layer, when having a thickness of 40 μm or less, contributes to a still more reduced weight of the synthetic leather.

A preferred embodiment of the synthetic leather according to the present invention has been described above with reference to FIG. 1. It should be noted, however, the synthetic leather according to the embodiment of the present invention is not limited to the embodiment as above. The synthetic leather according to the embodiment of the present invention does not always have to include the bonding layer 12 and the skin layer 14 as essential constituents. For example, the synthetic leather may have a structure without the bonding layer 12, a structure without the skin layer 14, or a structure without the bonding layer 12 and the skin layer 14. The synthetic leather according to the embodiment of the present invention may further include one or more layers other than the above-mentioned layers, within ranges not adversely affecting the advantageous effects of the present invention. A non-limiting example of the other layers is a primer layer for better adhesion between the foamed resin layer and the skin layer.

The synthetic leather according to the embodiment of the present invention includes a laminate that includes the fibrous substrate layer, the foamed resin layer, and the surface-protective layer disposed in the specified sequence (in particular, a laminate including the fibrous substrate layer, the bonding layer, the foamed resin layer, the skin layer, and the surface-protective layer), in which the fibrous substrate layer and the surface-protective layer define both end faces of the laminate. A preferred embodiment of the laminate will be described below. A non-limiting example of the laminate is the synthetic leather 1 illustrated in FIG. 1, which includes the fibrous substrate layer 11, the bonding layer 12, the foamed resin layer 13, the skin layer 14, and the surface-protective layer 15.

The laminate has a mass per unit area of preferably 300 to 500 g/m², and more preferably 350 to 460 g/m². The synthetic leather according to the embodiment of the present invention is lightweight and highly durable to abrasion. The synthetic leather can have a mass per unit area within the range, while having excellent abrasion durability.

The laminate preferably has a thickness of 1.0 to 1.3 mm. The laminate, when having a thickness of 1.0 mm or more, provides still better abrasion durability. In addition, the laminate resists wrinkling upon handling and has excellent working efficiency. The laminate, when having a thickness of 1.3 mm or less, can have a further reduced weight. This laminate can easily receive double stitching and has excellent working efficiency. In addition, the laminate, when having a thickness within the range, can be sheeted beautifully.

Assume that the laminate receives, on the surface-protective layer side, a rubbing test under a load of 1 kg with 30000 reciprocating rubbings as a test for color fastness to rubbing prescribed in JIS L0849. In the resulting laminate, the fibrous substrate layer preferably remains unexposed, and a layer lying immediately below the surface-protective layer (for example, the skin layer 14 in the synthetic leather 1 in FIG. 1) particularly preferably remains unexposed. The rubbing test is a rubbing test according to the Gakushin method, which is a severe testing under a load of 1 kg with 30000 rubbings. The synthetic leather according to the embodiment of the present invention, when having the configuration, has extremely excellent abrasion durability.

The laminate has a BLC softness of preferably 4.0 to 6.0, and more preferably 4.5 to 5.7. The laminate, when having a BLC softness of 4.0 or more, allows the synthetic leather according to the embodiment of the present invention to have a not excessively hard feel and texture. The laminate, when having a BLC softness of 6.0 or less, allows the synthetic leather according to the embodiment of the present invention to have a not excessively soft feel and texture. The laminate, when having a BLC softness within the range, allows the synthetic leather to have an appropriate feel and texture. The “BLC softness” refers to a strain measured as the depth by which a leather test piece sinks when pressed by a load of 500 g (per unit area). The BLC softness can be measured using a softness tester (trade name GT303 Leather Softness Tester, from GOTECH TESTING MACHINES INC.).

The foamed resin layer is present in a thickness ratio of preferably 10% to 60%, and more preferably 30% to 50%, of the total thickness (100%) of the laminate, while the foamed resin layer may be present in any other thickness ratio. The foamed resin layer, when present in a thickness ratio of 10% or more, allows the synthetic leather according to the embodiment of the present invention to have a more reduced weight while having better abrasion durability. The foamed resin layer, when present in a thickness ratio of 60% or less, allows the synthetic leather to have better abrasion durability, because the skin layer in the laminate can have a relatively sufficient thickness.

The laminate in the synthetic leather according to the embodiment of the present invention has a ratio of the thickness of a foamed layer(s) to the thickness of a non-foamed layer(s) of preferably 3.0 to 30.0, more preferably 5.0 to 20.0, and still more preferably 10.0 to 15.0. The laminate, when having a thickness ratio within the range, allows the synthetic leather according to the embodiment of the present invention to have a more reduced weight while having excellent abrasion durability. A non-limiting example of the foamed layer is the foamed resin layer. Non-limiting examples of the non-foamed layer include the skin layer and the surface-protective layer. The ratio of the thickness of the foamed resin layer to the total thickness of the skin layer and the surface-protective layer preferably falls within the range. The fibrous substrate layer and the bonding layer correspond to neither the foamed layer nor the non-foamed layer.

The synthetic leather 1, which is a synthetic leather according to an embodiment of the present invention, can be prepared typically in the following manner. Initially, a resin composition to form the skin layer 14 is applied to a surface of a release sheet to form a coat layer, which surface of the release sheet has received a surface release treatment. The coat layer then undergoes heating using a heater such as an oven to form the skin layer 14, typically through curing by acceleration of the reaction between an isocyanate and a polyol to form a polyurethane resin, through volatilization of a solvent, and/or through curing by the action of a crosslinker. The resin composition can be applied by a known or common technique, such as the techniques exemplified in the formation of the foamed resin layer according to the embodiment of the present invention.

Next, the foamed resin layer 13 is formed on the skin layer 14. The foamed resin layer 13 may be formed by a technique as with the technique for the formation of the foamed resin layer according to the embodiment of the present invention. It is preferred that the foamed resin layer 13 is separately prepared by calendering, and the prepared foamed resin layer 13 is laminated on the skin layer 14, where the lamination is performed with heating of the foamed resin layer before cooling, or performed by thermocompression bonding.

Next, an adhesive composition to form the bonding layer 12 is applied onto the foamed resin layer 13, the fibrous substrate layer 11 is placed on the applied adhesive composition, and the adhesive composition is cured typically by volatilization of the solvent using a heater such as an oven, to form the bonding layer 12. Thus, the fibrous substrate layer 11 is secured to the foamed resin layer 13 through the bonding layer 12. The fibrous substrate layer 11 is placed on the foamed resin layer 13 before curing of the adhesive composition. This allows the fibrous substrate layer 11 to be impregnated with the adhesive composition. The subsequent curing can form a structure in which the fibrous substrate layer 11 is impregnated with the bonding layer 12.

Next, the release sheet on the skin layer 14 is removed, and a resin composition to form the surface-protective layer 15 is applied onto the skin layer 14 to form a coat layer. The coat layer is then heated using a heater such as an oven and forms the surface-protective layer 15 typically through curing by the acceleration of the reaction between an isocyanate and a polyol to form a polyurethane resin, through solvent volatilization, and/or through curing by the action of a crosslinker. The resin composition can be applied by a known or common technique, such as the techniques exemplified in the formation of the foamed resin layer according to the embodiment of the present invention. The above procedure can give the synthetic leather 1 that includes, in the following sequence, the fibrous substrate layer 11, the bonding layer 12, the foamed resin layer 13, the skin layer 14, and the surface-protective layer 15.

The synthetic leather 1 as a synthetic leather according to an embodiment of the present invention can be prepared not only by the above method, but also by a method described below. Initially, an adhesive composition for the formation of the bonding layer 12 is applied onto the fibrous substrate layer 11, the coated adhesive composition is cured typically by solvent volatilization using a heater such as an oven, to form the bonding layer 12. This gives a laminate including the fibrous substrate layer 11 lying over the bonding layer 12. This method allows the fibrous substrate layer 11 to be impregnated with the adhesive composition, and the subsequent curing forms a structure in which the fibrous substrate layer 11 is impregnated with the bonding layer 12.

Next, the foamed resin layer 13 forms on the bonding layer 12 in the laminate. The foamed resin layer 13 may form by a technique as with the technique for the formation of the foamed resin layer according to the embodiment of the present invention. It is preferred that the foamed resin layer 13 is separately prepared by calendering, and the prepared foamed resin layer 13 is laminated on the bonding layer 12, where the lamination is performed with heating of the foamed resin layer before cooling, or performed by thermocompression bonding.

Next, a resin composition to form the skin layer 14 is applied onto the foamed resin layer 13 to form a coat layer. The coat layer is heated using a heater such as an oven, to form the skin layer 14 typically through curing by the acceleration of the reaction between an isocyanate and a polyol to form a polyurethane resin, through solvent volatilization, and/or through curing by the action of a crosslinker. The resin composition can be applied by a known or common technique, such as the techniques exemplified in the formation of the foamed resin layer according to the embodiment of the present invention.

Next, a resin composition to form the surface-protective layer 15 is applied onto the skin layer 14 to form a coat layer. The coat layer is then heated using a heater such as an oven, to form the surface-protective layer 15, typically through curing by the acceleration of the reaction between an isocyanate and a polyol to form a polyurethane resin, through solvent volatilization, and/or through curing by the action of a crosslinker. The resin composition can be applied by a known or common technique, such as the techniques exemplified in the formation of the foamed resin layer according to the embodiment of the present invention. The above procedure can give the synthetic leather 1, which includes, in the following sequence, the fibrous substrate layer 11, the bonding layer 12, the foamed resin layer 13, the skin layer 14, and the surface-protective layer 15.

The surface-protective layer 15 may be grained (boarded) on its surface by embossing.

The foamed resin layer according to the embodiment of the present invention can provide a synthetic leather that is lightweight and highly durable to abrasion. The foamed resin layer according to the embodiment of the present invention can also provide a synthetic leather that has a good feel and texture, and excellent flexing durability (in particular, excellent low-temperature flexing durability). The synthetic leather according to the embodiment of the present invention is lightweight and highly durable to abrasion. In addition, the synthetic leather according to the embodiment of the present invention has a good feel and texture and excellent flexing durability (in particular, excellent low-temperature flexing durability). A synthetic leather, when having excellent low-temperature flexing durability, resists cracking even used in a low-temperature environment. In general, a soft synthetic leather tends to have poor abrasion durability, in spite of having high flexing durability. In contrast, a hard (stiff) synthetic leather tends to have poor flexing durability, in spite of having high abrasion durability. Thus, there is generally a trade-off between abrasion durability and flexing durability. In contrast, the synthetic leather according to the embodiment of the present invention has abrasion durability and flexing durability both at high levels.

### EXAMPLES

The present invention will be illustrated in further detail with reference to several examples below. It should be noted, however, that these examples are never construed to limit the scope of the invention. The amounts given in the table are proportions of components (namely, proportions of active ingredients in materials; so-called “contents”) and are given in “part by mass”, unless otherwise specified.

### Example 1

A poly(vinyl chloride) adhesive was applied in a mass of coating of 15 g/m² to one side of a fibrous substrate (textile base; trade name CU19302, from savings-textile, mass per unit area: 185 g/m², thickness: 600 μm), dried to form a bonding layer, and yielded a laminate including the fibrous substrate and the bonding layer lying on each other. Separately, a resin composition was prepared by mixing materials, kneading them at 160° C. for 5 minutes, and cooling the kneadate, where the materials were: 100 parts by mass of a poly(vinyl chloride) (average degree of polymerization: 2000), 10 parts by mass of a thermoplastic polyurethane elastomer (Shore A hardness: 75, melting point: 170° C.), 90 parts by mass of a dialkyl phthalate plasticizer, 2.5 parts by mass of a blowing agent (azodicarbonamide), and 15 parts by mass of additives (including a filler, a stabilizer, a light fastness improver, a pigment, and a flame retardant). The resulting resin composition formed into a sheet by calendering to give an unfoamed resin sheet. Subsequently, the unfoamed resin sheet in a heated state was placed on the bonding layer of the laminate, followed by heating at 210° C. for 2 minutes to allow the blowing agent to expand. This gave a resin foam having a thickness of 500 μm. Next, the resin foam was coated with a composition using a reverse coater to form a coat layer thereon, and the coat layer heated at 130° C. for 5 minutes and thereby dried and crosslinked to form a skin layer having a thickness of 30 μm, where the composition had been prepared by mixing 100 parts by mass of an aqueous polycarbonate polyurethane resin (trade name HYDRAN WLS-210, from DIC Corporation) with 10 parts by mass of a pigment, 0.3 part by mass of a wettability improver, 0.3 part by mass of an antifoaming agent, and 3 parts by mass of a crosslinker. Next, the skin layer was coated with a composition using a reverse coater to form a coat layer thereon, and the coat layer heated at 130° C. for 5 minutes, and thereby dried and crosslinked to form a surface-protective layer having a thickness of 20 μm, where the composition had been prepared by mixing an aqueous polycarbonate polyurethane resin (trade name WF-78-143, from Stahl) with a silicone compound (trade name HM-54-002, from Stahl) and a carbodiimide crosslinker. The formed surface-protective layer was grained by embossing, and this yielded a synthetic leather.

### Examples 2 to 9, Comparative Example 1

A series of synthetic leathers was prepared by a procedure similar to that in Example 1, except for using a different poly(vinyl chloride) resin, using a different thermoplastic polyurethane elastomer, and/or using the components in different proportions as given in Table 1.

### Example 10

A synthetic leather was prepared by a procedure similar to that in Example 1, except for using 5.0 parts by mass of thermally expandable microcapsules, as a blowing agent instead of the azodicarbonamide.

Evaluations

The synthetic leathers obtained in the examples and the comparative example were evaluated in the following manner. The results are presented in Table 1. The foamed resin layers obtained in the examples and the comparative example had apparent densities as given in the table.

(1) Abrasion Durability Determined by Gakushin Method

From each synthetic leather obtained in the examples and the comparative example, one test specimen having a width of 10 mm and a length of 150 mm was sampled in the longitudinal direction. To the backside (fibrous substrate layer side) of the test specimen, a urethane foam having a width of 10 mm, a length of 15 mm, and a thickness of 3 mm was applied. The resulting test specimen underwent a rubbing test with a cotton cloth No. 6 prescribed in JIS L3102 using Gakushin-type Color Fastness to Rubbing Tester (rubbing tester type II; from DAIEI KAGAKU SEIKI MFG. Co., Ltd.) according to JIS L0849. The test specimen was rubbed with the cotton cloth under a load of 1 kg with 30000 reciprocating rubbings. The test specimen (surface-protective layer surface) after the rubbings was visually observed and evaluated for abrasion durability determined by the Gakushin method, according to the following criteria.

### Criteria:

Good (satisfactory): the surface-protective layer remains without shaving off by abrasion, and the skin layer remains unexposed;

Fair (usable): the surface-protective layer is shaved off by abrasion, but the fibrous substrate layer remains unexposed; and

Poor (inferior): the fibrous substrate layer is exposed.

(2) Low-Temperature Flexing Durability

From each synthetic leather obtained in the examples and the comparative example, each one test specimen having a width of 40 mm and a length of 70 mm was sampled in the longitudinal direction and in the width direction. Each test specimen received a bending load repeatedly at a predetermined stroke in conformity to JIS K6260, using De Mattia Tester FT-1521 (from Ueshima Seisakusho Co., Ltd.). The bending was repeated 30000 times at −10° C., and the test specimen was evaluated by cracking for flexing durability. The flexing durability of each test specimen was determined according to the following criteria. The average of the cracking lengths in the longitudinal test specimen and the cracking length in the width direction test specimen was defined as the length of cracking.

### Criteria:

Good (satisfactory): without cracking;

Fair (usable): without cracking, but with whitening (hazing); and

Poor (inferior): with cracking.

(3) BLC Stiffness/Softness (Feel and Texture)

From each synthetic leather obtained in the examples and the comparative example, one 150-mm square test specimen was sampled. A strain (BLC softness) was measured as the depth by which the test specimen sank when pressed by a load of 500 g, using GT303 Leather Softness Tester (from GOTECH TESTING MACHINES INC.). The larger the measured strain is, the softer feel and texture the synthetic leather has.

(4) Calenderability

In the examples and the comparative example, calenderability (calendaring processability) in preparation of an unfoamed resin sheet by calendering in the course of the formation of a foamed resin layer was evaluated according to the following criteria.

### Criteria:

Good (satisfactory): An unfoamed resin sheet having a homogeneous thickness can be recovered from the calender rolls;

Fair (usable) Kneading to recover an unfoamed resin sheet takes equal to or more than two times the time taken by a sample having a good calenderability; and

Poor (inferior): An unfoamed resin sheet can be recovered after a kneading time as long as two times or more the kneading time for a good sample, but the unfoamed resin sheet has a heterogeneous thickness.

(5) Asker C Hardness

The foamed resin layers obtained in the examples and the comparative example were evaluated for Asker C hardness by measurement according to JIS K7312 using ASKER Durometer (Rubber Hardness Tester) Type C (from Kobunshi Keiki Co., Ltd.).

TABLE 1

| | | | Examples | | | | | | | | | | Com. |
|---|---|---|---|---|---|---|---|---|---|---|---|---|---|
| | | | 1 | 2 | 3 | 4 | 5 | 6 | 7 | 8 | 9 | 10 | Ex. 1 |
| Evaluation | Mass per unit area (g/m²) | | 450 | 450 | 500 | 450 | 450 | 450 | 400 | 450 | 450 | 450 | 450 |
| results | Thickness (mm) | | 1.1 | 1.1 | 1.3 | 1.1 | 1.1 | 1.0 | 1.0 | 1.1 | 0.9 | 1.1 | 1.1 |
| | Ratio of thickness of | | 10.0 | 10.0 | 20.8 | 10.0 | 10.0 | 8.0 | 6.0 | 10.0 | 6.0 | 10.0 | 10.0 |
| | foamed layer to thickness | | | | | | | | | | | | |
| | of non-foamed layer | | | | | | | | | | | | |
| | Abrasion durability | | Good | Good | Good | Good | Good | Good | Good | Good | Good | Good | Poor |
| | determined by | | | | | | | | | | | | |
| | Gakushin method | | | | | | | | | | | | |
| | Low-temperature flexing | | Good | Good | Good | Good | Good | Good | Good | Fair | Good | Good | Good |
| | durability | | | | | | | | | | | | |
| | BLC softness | | 5.2 | 5.3 | 5.6 | 5.4 | 5.5 | 4.8 | 4.9 | 4.3 | 3.8 | 4.8 | 5.0 |
| Foamed | Thickness of unfoamed | | 200 | 200 | 250 | 200 | 200 | 200 | 150 | 200 | 200 | 200 | 200 |
| resin | resin sheet (μm) | | | | | | | | | | | | |
| layer | TPU | Shore A | 75 | 75 | 75 | 50 | 75 | 75 | 75 | 90 | 75 | 75 | — |
| | | hardness | | | | | | | | | | | |
| | | Amount | 10 | 40 | 10 | 10 | 10 | 10 | 10 | 10 | 10 | 10 | 0 |
| | | Melting | 170 | 170 | 170 | 160 | 170 | 170 | 170 | 190 | 170 | 170 | — |
| | | point (° C.) | | | | | | | | | | | |
| | PVC | Average | 2000 | 2000 | 2000 | 2000 | 1300 | 3000 | 2000 | 2000 | 2000 | 2000 | 2000 |
| | | polymer- | | | | | | | | | | | |
| | | ization | | | | | | | | | | | |
| | | degree | | | | | | | | | | | |
| | | Amount | 100 | 100 | 100 | 100 | 100 | 100 | 100 | 100 | 100 | 100 | 100 |
| | Plasticizer | Amount | 90 | 90 | 90 | 90 | 90 | 90 | 90 | 90 | 90 | 90 | 90 |
| | Blowing agent | Amount | 2.5 | 2.5 | 2.5 | 2.5 | 2.5 | 2.5 | 2.5 | 2.5 | 1.5 | 5.0 | 2.5 |
| | Additives | Amount | 15 | 15 | 15 | 15 | 15 | 15 | 15 | 15 | 15 | 15 | 15 |
| | (filler, | | | | | | | | | | | | |
| | stabilizer, | | | | | | | | | | | | |
| | light | | | | | | | | | | | | |
| | fastness | | | | | | | | | | | | |
| | improver, | | | | | | | | | | | | |
| | pigment, | | | | | | | | | | | | |
| | and flame | | | | | | | | | | | | |
| | retardant) | | | | | | | | | | | | |

| | | | | | | | | | | | | |
|---|---|---|---|---|---|---|---|---|---|---|---|---|
| | Apparent density (g/cm³) | 0.40 | 0.40 | 0.40 | 0.40 | 0.40 | 0.50 | 0.50 | 0.40 | 0.67 | 0.40 | 0.40 |
| | Thickness after expansion (μm) | 500 | 500 | 625 | 500 | 500 | 400 | 300 | 500 | 300 | 500 | 500 |
| | Expansion ratio | 2.4 | 2.1 | 2.3 | 2.3 | 2.2 | 1.9 | 1.8 | 2.1 | 1.7 | 2.0 | 2.4 |
| | Maximum cell size (μm) | 200 | 170 | 210 | 200 | 220 | 170 | 150 | 290 | 160 | 100 | 250 |
| | Average cell size (μm) | 130 | 120 | 150 | 140 | 150 | 110 | 130 | 200 | 80 | 60 | 160 |
| | Asker C hardness | 33 | 35 | 31 | 32 | 30 | 36 | 32 | 39 | 37 | 40 | 35 |
| | Calenderability of foamed | Good | Fair | Good | Good | Good | Fair | Good | Poor | Good | Good | Good |
| | resin layer | | | | | | | | | | | |
| fibrous | Mass per unit area (g/m²) | 185 | 185 | 185 | 185 | 185 | 185 | 185 | 185 | 185 | 185 | 185 |
| Substrate | | | | | | | | | | | | |
| layer | | | | | | | | | | | | |
| Skin layer | Thickness (μm) | 30 | 30 | 20 | 30 | 30 | 30 | 30 | 30 | 30 | 30 | 30 |
| Surface- | Thickness (μm) | 20 | 20 | 10 | 20 | 20 | 20 | 20 | 20 | 20 | 20 | 20 |
| protective | | | | | | | | | | | | |
| layer | | | | | | | | | | | | |

The synthetic leathers according to the embodiment of the present invention (Examples), which include the foamed resin layer according to the embodiment of the present invention, resisted shaving off of the surface-protective layer even by the severe Gakushin-type rubbing test under a load of 1 kg with 30000 rubbings and had excellent abrasion durability, even though having such a light weight of 500 g/m² or less. The samples using a thermoplastic polyurethane elastomer having a Shore A hardness of 80 or less in the foamed resin layer (Examples 1 to 7, and 9) also had excellent low-temperature flexing durability. The sample using a foamed resin layer having an expansion ratio of 2.0 times or more (Example 1 to 8) had an adequate BLC softness and had an excellent feel and texture. In contrast, the sample using a foamed resin layer devoid of thermoplastic polyurethane elastomers (Comparative Example 1) had poor abrasion durability.

### REFERENCE SIGNS LIST

1 synthetic leather
11 fibrous substrate layer
12 bonding layer
13 foamed resin layer
14 skin layer
15 surface-protective layer

1. A foamed resin layer comprising:
a poly(vinyl chloride) resin; and
a thermoplastic polyurethane elastomer.

2. The foamed resin layer according to claim 1,
wherein the thermoplastic polyurethane elastomer has a Shore A hardness of 50 to 80.

3. The foamed resin layer according to claim 1,
which has an apparent density of 0.3 to 0.7 g/cm³.

4. The foamed resin layer according to claim 1,
which has an average cell size of 50 to 250 μm.

5. The foamed resin layer according to claim 1,
which has a closed-cell structure.

6. The foamed resin layer according to claim 1,
wherein the thermoplastic polyurethane elastomer is present in a proportion of 1 to 50 parts by mass per 100 parts by mass of the poly(vinyl chloride) resin.

7. The foamed resin layer according to claim 1,
further comprising a plasticizer.

8. The foamed resin layer according to claim 7,
wherein the plasticizer is present in a proportion of 40 to 90 parts by mass per 100 parts by mass of the poly(vinyl chloride) resin.

9. The foamed resin layer according to claim 1,
which is for use in a synthetic leather for an automobile interior.

10. A synthetic leather comprising
the foamed resin layer according to claim 1.

11. The synthetic leather according to claim 10, comprising, in the sequence set forth:
a fibrous substrate layer;
the foamed resin layer; and
a skin layer including a polyurethane resin,
the fibrous substrate layer and the foamed resin layer bonding with each other through a bonding layer derived mainly from a poly(vinyl chloride) resin.

12. A synthetic leather including a laminate comprising, in the sequence set forth:
a fibrous substrate layer;
a foamed resin layer; and
a surface-protective layer,
the surface-protective layer defining an outermost surface of the laminate,
the fibrous substrate layer and the surface-protective layer defining both end faces of the laminate,
the laminate having a mass per unit area of 300 to 500 g/m² and a thickness of 1.0 to 1.3 mm,
in the laminate, a layer lying immediately below the surface-protective layer remaining unexposed when the laminate receiving a rubbing test on the surface-protective layer side, where the rubbing test is performed under a load of 1 kg with 30000 reciprocating rubbings as a test for color fastness to rubbing prescribed in Japanese Industrial Standards (JIS) L0849,
the laminate having a BLC softness of 4.0 to 6.0.

13. A synthetic leather including a laminate comprising, in the sequence set forth:
a fibrous substrate layer;
a foamed resin layer; and
a surface-protective layer,
the surface-protective layer defining an outermost surface of the laminate,
the fibrous substrate layer and the surface-protective layer defining both end faces of the laminate,
the laminate having a mass per unit area of 300 to 500 g/m² and a thickness of 1.0 to 1.3 mm,
in the laminate, a layer lying immediately below the surface-protective layer remaining unexposed when the laminate receiving a rubbing test on the surface-protective layer side, where the rubbing test is performed under a load of 1 kg with 30000 reciprocating rubbings as a test for color fastness to rubbing prescribed in Japanese Industrial Standards (JIS) L0849,
the laminate having a BLC softness of 4.0 to 6.0,
wherein the foamed resin layer is the foamed resin layer according to claim 1.

14. The foamed resin layer according to claim 2,
which has a closed-cell structure.

15. The foamed resin layer according to claim 2,
wherein the thermoplastic polyurethane elastomer is present in a proportion of 1 to 50 parts by mass per 100 parts by mass of the poly(vinyl chloride) resin.

16. The foamed resin layer according to claim 15,
further comprising a plasticizer.

17. The foamed resin layer according to claim 16,
wherein the plasticizer is present in a proportion of 40 to 90 parts by mass per 100 parts by mass of the poly(vinyl chloride) resin.

18. A synthetic leather including a laminate comprising, in the sequence set forth:
a fibrous substrate layer;
a foamed resin layer; and
a surface-protective layer,
the surface-protective layer defining an outermost surface of the laminate,
the fibrous substrate layer and the surface-protective layer defining both end faces of the laminate,
the laminate having a mass per unit area of 300 to 500 g/m² and a thickness of 1.0 to 1.3 mm,
in the laminate, a layer lying immediately below the surface-protective layer remaining unexposed when the laminate receiving a rubbing test on the surface-protective layer side, where the rubbing test is performed under a load of 1 kg with 30000 reciprocating rubbings as a test for color fastness to rubbing prescribed in Japanese Industrial Standards (JIS) L0849,
the laminate having a BLC softness of 4.0 to 6.0,
wherein the foamed resin layer is the foamed resin layer according to claim 15.

19. A synthetic leather including a laminate comprising, in the sequence set forth:
a fibrous substrate layer;
a foamed resin layer; and
a surface-protective layer,
the surface-protective layer defining an outermost surface of the laminate,
the fibrous substrate layer and the surface-protective layer defining both end faces of the laminate,
the laminate having a mass per unit area of 300 to 500 g/m² and a thickness of 1.0 to 1.3 mm,
in the laminate, a layer lying immediately below the surface-protective layer remaining unexposed when the laminate receiving a rubbing test on the surface-protective layer side, where the rubbing test is performed under a load of 1 kg with 30000 reciprocating rubbings as a test for color fastness to rubbing prescribed in Japanese Industrial Standards (JIS) L0849,
the laminate having a BLC softness of 4.0 to 6.0,
wherein the foamed resin layer is the foamed resin layer according to claim 16.

20. A synthetic leather including a laminate comprising, in the sequence set forth:
a fibrous substrate layer;
a foamed resin layer; and
a surface-protective layer,
the surface-protective layer defining an outermost surface of the laminate,
the fibrous substrate layer and the surface-protective layer defining both end faces of the laminate,
the laminate having a mass per unit area of 300 to 500 g/m² and a thickness of 1.0 to 1.3 mm,
in the laminate, a layer lying immediately below the surface-protective layer remaining unexposed when the laminate receiving a rubbing test on the surface-protective layer side, where the rubbing test is performed under a load of 1 kg with 30000 reciprocating rubbings as a test for color fastness to rubbing prescribed in Japanese Industrial Standards (JIS) L0849,
the laminate having a BLC softness of 4.0 to 6.0,
wherein the foamed resin layer is the foamed resin layer according to claim 17.
